(19) United States
(12) Patent Application Publication
(10) Pub. No.: US 2022/0413139 A1
(43) Pub. Date: Dec. 29, 2022

(54) LASER DISTANCE MEASURING DEVICE SYSTEM ENABLING CHECKING TARGET POINT DISTANCE VALUE, DISTANCE VALUE BETWEEN SHOTS, AND GOLF SCORES, AND CHECKING METHOD USING SAME

(71) Applicant: TT&G., LTD., Daegu (KR)

(72) Inventor: Bae Hee LEE, Daegu (KR)

(21) Appl. No.: 17/778,657

(22) PCT Filed: Nov. 22, 2019
(86) PCT No.: PCT/KR2019/016188

§ 371 Date: May 20, 2022

(51) Int. Cl. G01S 17/08; G01S 19/19

(52) U.S. Cl. CPC G01S 17/08; G01S 19/19

(57) ABSTRACT

The present invention relates to a laser distance meter system and a checking method using the same that are capable of allowing a target distance value, a distance value between golf shots or putts or between a golf shot and a putt for the hole where a golfer finishes the game of golf, and a golf score such as bogey, birdie, eagle, and the like to be checked through a display part.

### TECHNICAL FIELD

The present invention relates to a laser distance meter system for checking a target distance value, a distance value between shots, and a golf score and a checking method using the same, and more specifically, to a laser distance meter system for checking a target distance value, a distance value between shots, and a golf score and a checking method using the same that are capable of allowing a golfer to check the target distance value and being simply pressed after golf shots or putts to check the distance value between the shots and the golf score when the golfer finishes the game of golf.

### BACKGROUND ART

In playing the game of golf, a golfer may win or lose according to whether he or she calculates a distance, a slope, and a height between him or her and a given point of a fairway or a pin on the green.

In conventional practices, a slope angle between the golfer and the distance mark or pin on the fairway is calculated based on the golfer's experiences and senses, which makes the accuracy in distance calculation deteriorated.

In the case of a beginner golfer, further, it is really hard to calculate the distance.

To solve such problems, recently, a distance between the golfer and the pin is provided through a global positioning system (GPS) terminal where information of holes in a golf course is pre-inputted, but in this case, the GPS terminal has to be periodically updated. Moreover, data of location changes of the pins in the existing golf course or data of a new golf course has to be all updated, which undesirably causes many inconveniences.

A conventional distance meter using laser, as disclosed in Korean Patent No. 10-1582400, includes: a body; a photographing part disposed on the body to photograph an image having a target; a display part connected to the body to display the image photographed by the photographing part so that a golfer aims at the target; a laser transceiver for transmitting laser to the target and receiving the laser reflected from the target through the display part; and a controller for calculating a distance value from a current location to the target, based on the signal outputted from the laser transceiver, wherein the display part includes an image element for outputting the image photographed by the photographing part and one or more optical lenses for transmitting the image outputted from the image element, and even if the display part is close to the golfer's eyes, the golfer can focus on the image.

In specific, the conventional distance meter using laser is capable of generally checking the distance from the current location to the target through the laser, but if a golf ball is hidden by an obstacle after a golf shot or putt, a carry distance of the golf ball cannot be accurately obtained. Besides, the number of strokes whenever the golfer hits golf shots or putts has to be memorized by the golfer or caddie so as to check, when the game of golf for each hole is finished, a golf score such as bogey, birdie, eagle, and the like on the corresponding hole.

### DISCLOSURE

### Technical Problem

Accordingly, the present invention has been made in view of the above-mentioned problems occurring in the related art, and it is an object of the present invention to provide a laser distance meter system for checking a target distance value, a distance value between shots, and a golf score and a checking method using the same that are capable of being provided with a par input part disposed on one side of a body to input the par for an individual hole in a golf course where the golfer plays the game of golf and a global positioning system (GPS) location storage part disposed on one side of the body and pressed by the golfer after his or her golf shot or putt to store a GPS location upon the golf shot or putt, so that the distance value between the golf shots or putts or between the golf shot and putt for the hole where the golfer finishes the game of golf and the golf score such as bogey, birdie, eagle, and the like are checked through a display part.

### Technical Solution

To accomplish the above-mentioned objects, according to the present invention, there is provided a laser distance meter system having a body 100, a camera 200 disposed on one side of the front surface of the body 100 to photograph a target in a golf course, a display part 300 disposed on one side of the rear surface of the body 100 to display the image photographed by the camera 200, a laser transceiver 400 disposed inside the camera 200 to transmit laser to the target in the golf course photographed by the camera 200 and receive the laser reflected from the target, and a distance value calculator 500 for calculating a distance value from a current location to the target, based on the signal outputted from the laser transceiver 400, to allow the calculated distance value to be displayed on the display part 300, the laser distance meter system including: a par input part 600 disposed on one side of the body 100 to input the par for a hole in the golf course where a golfer plays the game of golf; a global positioning system (GPS) location storage part 700 disposed on one side of the body 100 and pressed by the golfer after his or her golf shot or putt to store a GPS location upon the golf shot or putt; and a counter 800 for calculating the distance value between the golf shots or putts or between the golf shot and the putt, based on the locations stored in the GPS location storage part 700, and calculating a golf score, based on the par inputted to the part input part 600 and the number of times pressed of the GPS location storage part 700, to allow the distance value between the golf shots or putts or between the golf shot and the putt and the golf score for the hole where the golfer finishes the game of golf to be displayed on the display part 300.

A checking method using the laser distance meter system according to the present invention may include the steps of: allowing the par input part 600 to be pressed by the golfer so as to input the par for the hole where the golfer plays the game of golf (S100); providing the image photographed by the camera 200 and the distance value from the current location to the target photographed by the camera 200 through the display part 300 when the target in the golf course is photographed by the camera 200 (S200); allowing the GPS location storage part 700 to be pressed by the golfer after the golf shot or putt so as to store the GPS location upon the golf shot or putt (S300); and providing the distance value between the golf shots or putts or between the golf shot and the putt and the golf score for the hole where the golfer finishes the game of golf for the golfer through the display part 300 (S400).

### Advantageous Effects

According to the present invention, the laser distance meter system for checking the target distance value, the distance value between the shots, and the golf score and the checking method using the same can achieve the inherent object thereof so that the distance value from the current location to the target is checked by means of the laser, allow the carry distance of the golf ball with respect to each hole and the moving path of the golf ball to be easily checked after the game of golf for each hole is finished, and allow the golf score to be easily checked even though the number of strokes every golf shot or putt is not memorized by the caddie or golfer so that the golfer can be perfectly concentrated on playing the game of golf.

### DESCRIPTION OF DRAWINGS

FIG. 1 is a block diagram showing a laser distance meter system according to the present invention.

FIG. 2 is a flowchart showing a checking method using the laser distance meter system according to the present invention.

100: Body

200: Camera

300: Display part

400: Laser transceiver

500: Distance value calculator

600: Par input part

700: GPS location storage part

800: Counter

S100: Step of inputting par

S200: Step of providing distance value

S300: Step of storing GPS location

S400: Step of providing distance value between shots and golf score

### BEST MODE FOR INVENTION

The present invention relates to a distance value between shots, and a golf score and a checking method using the same, and more specifically, to a laser distance meter system for checking a target distance value, a distance value between shots, and a golf score and a checking method using the same that are capable of allowing a golfer to check the target distance value and being simply pressed after golf shots or putts to check the distance value between the shots and the golf score when the golfer finishes the game of golf.

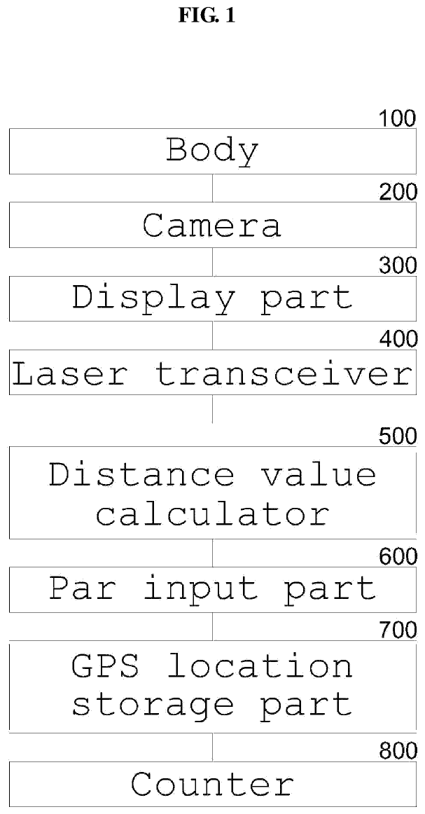

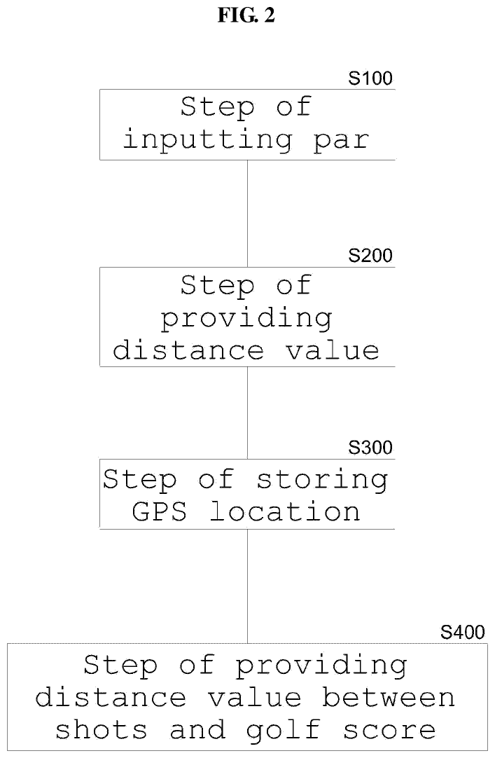

Hereinafter, an explanation of the configuration and operation of the present invention will be given with reference to FIGS. 1 and 2.

Referring first to FIG. 1, there is provided a laser distance meter system according to the present invention having a body 100, a camera 200 disposed on one side of the front surface of the body 100 to photograph a target in a golf course, a display part 300 disposed on one side of the rear surface of the body 100 to display the image photographed by the camera 200, a laser transceiver 400 disposed inside the camera 200 to transmit laser to the target in the golf course photographed by the camera 200 and receive the laser reflected from the target, and a distance value calculator 500 for calculating a distance value from a current location to the target, based on the signal outputted from the laser transceiver 400, to allow the calculated distance value to be displayed on the display part 300, the laser distance meter system including: a par input part 600 disposed on one side of the body 100 to input the par for a hole in the golf course where a golfer plays the game of golf; a GPS location storage part 700 disposed on one side of the body 100 and pressed by the golfer after his or her golf shot or putt to store a GPS location upon the golf shot or putt; and a counter 800 for calculating the distance value between the golf shots or putts or between the golf shot and the putt, based on the locations stored in the GPS location storage part 700, and calculating a golf score, based on the par inputted to the part input part 600 and the number of times pressed of the GPS location storage part 700, to allow the distance value between the golf shots or putts or between the golf shot and the putt and the golf score for the hole where the golfer finishes the game of golf to be displayed on the display part 300.

Generally, the conventional laser distance meter system, which is capable of checking a target distance value, includes the body 100, the camera 200, the display part 300, the laser transceiver 400, and the distance value calculator 500.

The body 100 is desirably grasped by one hand of the golfer and serves as a part on which the camera 200, the display part 300, the laser transceiver 400, and the like are mounted.

The camera 200 is disposed on one side of the front surface of the body 100 to allow the golfer to photograph the target in the golf course.

In this case, the camera 200 is desirably connected to the display part 300 to allow the golfer to check the image photographed thereby on the display part 300, and the camera 200 may be provided as a general camera module in the conventional practice.

The display part 300 is disposed on one side of the rear surface of the body 100 to allow the golfer to check the image photographed by the camera 200.

In specific, the display part 300 serves to allow the golfer to check the target in the golf course photographed through the camera 200, while being checked and controlled by him or her, so that the target in the golf course can be easily photographed.

In this case, the display part 300 may be provided as one of various display parts, such as an LED display part, an LCD display part, and the like, which are used in the conventional practice.

The laser transceiver 400 is disposed inside the camera 200 to transmit laser to the target in the golf course photographed by the camera 200 and receive the laser reflected from the target.

In this case, the laser transceiver 400 is desirably disposed coaxially with the camera 200 inside the camera 200, so that the laser can be accurately transmitted to the target in the golf course photographed by the camera 200.

Further, the laser transceiver 400 is operable by means of a separate on/off switch, and if the laser transceiver 400 is turned on through the on/off switch, desirably, the laser is consistently transmitted and received, so that the distance value from a current location to the target, which is changed in real time whenever the target is changed according to the location adjustment of the camera 200 carried out by the golfer, is displayed on the display part 300 to allow him or her to easily check the distance value from the current location to the target.

The distance value calculator 500 serves to calculate the distance value from the current location to the target, based on the signal outputted from the laser transceiver 400, and display the calculated distance value on the display part 300.

In specific, the distance value calculator 500 calculates the distance value from the current location where the laser is transmitted to the target, based on the signal reflected from the target in the golf course after the laser is transmitted from the laser transceiver 400 and thus reaches the target in the golf course.

As the key parts of the present invention, further, the laser distance meter system according to the present invention includes the par input part 600, the GPS location storage part 700, and the counter 800.

The par input part 600 is disposed on one side of the body 100 to input the par for a hole in the golf course where the golfer arrives before he or she plays the game of golf.

In this case, the par input part 600 is provided in the form of a button structure in the conventional practice so that the number of strokes is pressed by the golfer to input the corresponding par, and otherwise, the par input part 600 is provided in the form of a keypad in the conventional practice so that the number corresponding to the par is conveniently pressed to input the corresponding par. Further, the par input part 600 may be provided in the form of a touch screen in the conventional practice.

The GPS location storage part 700 is disposed on one side of the body 100 and pressed by the golfer after his or her golf shot or putt to thus store the GPS location upon the golf shot or putt.

In this case, the GPS location storage part 700 is desirably provided in the form of a button structure pressed by the golfer after his or her golf shot or putt, and desirably, the GPS location storage part 700 includes a general GPS receiver disposed therein to store the GPS location where a golf ball is positioned at the time when pressed by the golfer.

Further, the GPS location storage part 700 desirably stores the number of times pressed by the golfer at the time when pressed by him or her.

The counter 800 serves to calculate the distance value between the golf shots or putts or between the golf shot and the putt, based on the location stored in the GPS location storage part 700, and calculate the golf score, based on the par inputted to the part input part 600 and the number of times pressed of the GPS location storage part 700, to thus allow the distance value between the golf shots or putts or between the golf shot and the putt and the golf score for each hole where the golfer finishes the game of golf to be displayed on the display part 300.

In specific, the counter 800 is connected to the GPS location storage part 700 and the display part 300 to calculate the distance value between the respective shots, based on the GPS location upon the golf shot or putt received from the GPS location storage part 700, and to allow a carry distance of the golf ball and a moving path of the golf ball on the hole where the golfer finishes the game of golf to be displayed on the display part 300.

Further, the counter 800 may be connected to the par input part 600, the GPS location storage part 700, and the display part 300 to allow the par received from the par input part 600 and the golf score such as bogey, birdie, eagle, and the like, based on the number of times pressed of the GPS location storage part 700, to be displayed on the display part 300.

Through the counter 800, in specific, the information of the game of golf played on the hole where the golfer finishes the game of golf, which is displayed on the display part 300, can be immediately checked by the golfer, and further, he or she gets feedback from the information. Even though the number of strokes every golf shot or putt is not memorized by a caddie or the golfer, moreover, the golf score can be easily checked to thus enable the golfer to be perfectly concentrated on playing the game of golf.

Next, a checking method using the laser distance meter system capable of checking the target distance value, the distance value between the shots, and the golf score according to the present invention will be explained.

A. Step of Inputting Par (S100)

The step of inputting par (S100) is carried out to allow the par input part 600 to be pressed by the golfer so as to input the par for the hole where he or she plays the game of golf thereto.

Through the step of inputting par (S100), in specific, the par for each hole in the golf course where the game of golf is played is inputted by the golfer before the game of golf is played, so that the par for each hole is inputted to thus calculate a golf score at step of providing the distance value between shots and the golf score (S400) as will be discussed later.

B. Step of Providing Distance Value (S200)

The step of providing the distance value (S200) is carried out to provide the image photographed by the camera 200 and the distance value from the current location to the target photographed by the camera 200 through the display part 300 when the target in the golf course is photographed by the camera 200.

Through the step of providing the distance value (S200), in specific, when the distance value from the current location to the target is needed for the golfer, the distance value from the body 100 where the laser transceiver 400 is located to the target is provided for the golfer through the display part 300, thereby being helpful in playing the game of golf of the golfer.

C. Step of Storing a GPS Location (S300)

The step of storing the GPS location (S300) is carried out to allow the GPS location storage part 700 to be pressed by the golfer after the golf shot or putt so as to store the GPS location upon the golf shot or putt.

Through the step of storing the GPS location (S300), in specific, the GPS location storage part 700 is pressed by the golfer after the golf shot or putt so as to store the GPS location at which the golf ball is positioned upon the golf shot or putt, so that the GPS location at which the golf ball is located every golf shot or putt is stored, which is needed in calculating the distance value between the shots at the step of providing the distance value between the shots and the golf score (S400) as will be discussed later.

D. Step of Providing the Distance Value Between Shots and Golf Score (S400)

The step of providing the distance value between the shots and the golf score (S400) is carried out to provide the distance value between the golf shots or putts or between the golf shot and the putt and the golf score for the hole where the golfer finishes the game of golf for the golfer through the display part 300.

Through the step of providing the distance value between shots and the golf score (S400), in specific, the information of the game of golf played on each hole where the game of golf is finished, such as the distance value between the shots and the golf score, is provided for the golfer and checked by him or her.

According to the present invention, therefore, the laser distance meter system for checking the target distance value, the distance value between the shots, and the golf score and the checking method using the same can achieve the inherent object thereof so that the distance value from the current location to the target is checked by means of the laser, allow the carry distance of the golf ball with respect to each hole and the moving path of the golf ball to be easily checked after the game of golf for each hole is finished, and allow the golf score to be easily checked even though the number of strokes every golf shot or putt is not memorized by the caddie or golfer so that the golfer can be perfectly concentrated on playing the game of golf.

1. A laser distance meter system having a body (100), a camera (200) disposed on one side of the front surface of the body (100) to photograph a target in a golf course, a display part (300) disposed on one side of the rear surface of the body (100) to display the image photographed by the camera (200), a laser transceiver (400) disposed inside the camera (200) to transmit laser to the target in the golf course photographed by the camera (200) and receive the laser reflected from the target, and a distance value calculator (500) for calculating a distance value from a current location to the target, based on the signal outputted from the laser transceiver (400), to allow the calculated distance value to be displayed on the display part (300), the laser distance meter system comprising:
a par input part (600) disposed on one side of the body (100) to input the par for a hole in the golf course where a golfer plays the game of golf;
a global positioning system (GPS) location storage part (700) disposed on one side of the body (100) and pressed by the golfer after his or her golf shot or putt to store a GPS location upon the golf shot or putt; and
a counter (800) for calculating the distance value between the golf shots or putts or between the golf shot and the putt, based on the locations stored in the GPS location storage part (700), and calculating a golf score, based on the par inputted to the part input part (600) and the number of times pressed of the GPS location storage part (700), to allow the distance value between the golf shots or putts or between the golf shot and the putt and the golf score for the hole where the golfer finishes the game of golf to be displayed on the display part (300).

2. A checking method using the laser distance meter system as defined in claim 1, comprising the steps of:
allowing the par input part (600) to be pressed by the golfer so as to input the par for the hole where the golfer plays the game of golf (S100);
providing the image photographed by the camera (200) and the distance value from the current location to the target photographed by the camera (200) through the display part (300) when the target in the golf course is photographed by the camera (200) (S200);
allowing the GPS location storage part (700) to be pressed by the golfer after the golf shot or putt so as to store the GPS location upon the golf shot or putt (S300); and
providing the distance value between the golf shots or putts or between the golf shot and the putt and the golf score for the hole where the golfer finishes the game of golf for the golfer through the display part (300) (S400).
